(19) United States
(12) Patent Application Publication
(10) Pub. No.: US 2025/0181430 A1
(43) Pub. Date: Jun. 5, 2025

(54) SYSTEMS CONFIGURED WITH A NETWORK COMMUNICATIONS ARCHITECTURE FOR ELECTRONIC MESSAGING AND METHODS OF USE THEREOF

(71) Applicant: PITTWAY SARL, Rolle (CH)

(72) Inventors: Dipti Gadhia, London (GB); Michael Stearns, Saint Augustine, FL (US); Joseph Raymond Zwack, Robbinsdale, MN (US); Roger Hernandez, Hollywood, FL (US); Isao Jonas, Austin, TX (US)

(73) Assignee: PITTWAY SARL, Rolle (CH)

(21) Appl. No.: 18/833,662

(22) PCT Filed: Jan. 27, 2022
(86) PCT No.: PCT/IB2022/000033

§ 371 Date: Jul. 26, 2024

(51) Int. Cl. G06F 9/54

(52) U.S. Cl. CPC G06F 9/546; G06F 9/547

(57) ABSTRACT

Embodiments of the present disclosure enable electronic messaging using a network communications architecture, including receiving, by processor via a status application programming interface (API) of an administration service, a performance incident indication indicative of a performance incident associated with an application service. The administration service determines a performance incident status based at least in part on the performance incident indication and determines a message having a notification of the performance incident. The administration service determines front-ends associated with the application service. The administration service generates, using front-end specific adapters of the status API, a front-end specific API call to each front-end to update each front-end with the message with content and formatting specific to each front-end. The administration service generates, using a public status page specific adapter of the status API, public status page specific API call to public status page to update the public status page with the message.

### FIELD OF TECHNOLOGY

The present disclosure generally relates to computer-based systems configured for network communication architecture for electronic messaging, including for selective deployment of system status messages and methods of use thereof.

### BACKGROUND OF TECHNOLOGY

Software applications and services may be presented to users via a variety of front-ends. Examples can include mobile applications, desktop applications, web-based applications (“web apps”), dashboard utilities, among other endpoints. Each front-end may receive information from a back-end system that provides functionality to each front-end. The back-end systems, such as servers, cloud systems, microservices, databases, and other back-end components, may experience performance changes and/or outages that affect the functionality of one or more front-ends, as well as other status updates and informational updates.

### SUMMARY OF DESCRIBED SUBJECT MATTER

The present disclosure provides one or more embodiments of a method for electronic messaging using a network communications architecture. The method includes: receiving, by at least one processor via a particular application programming interface (API) of an administration service, a performance incident indication indicative of a performance incident associated with at least one application service; where the performance incident indication includes: an incident type identifier identifying a type of the performance incident and at least one application service identifier identifying the at least one application service; determining, by the at least one processor, using the administration service, a performance incident status based at least in part on the performance incident indication; determining, by the at least one processor, using the administration service, at least one message including a notification of the performance incident based at least in part on: the performance incident status and the incident type identifier; determining, by the at least one processor, using the administration service, at least one front-end associated with the at least one application service; generating, by the at least one processor, using at least one front-end specific adapter of a plurality of adapters of the particular API, at least one front-end specific API call to the at least one front-end; updating, by the at least one processor, the at least one front-end with the at least one message using the at least one front-end specific API call so as to cause the at least one front-end to render the at least one message with front-end specific formatting; generating, by the at least one processor, using at least one public status page specific adapter of a plurality of adapters of the particular API, at least one public status page specific API call to at least one public status page; updating, by the at least one processor, using the at least one public status page specific adapter of the plurality of adapters of the particular API, the at least one public status page with the at least one message using the at least one public status page specific API call so as to cause the at least one public status page to render the at least one message with public status page specific formatting; and updating, by the at least one processor, a user interface of the administrative service to present an application status indicating that the at least one front-end is updated with the at least one message.

In one or more embodiments, the method further includes where the performance incident indication includes a geographic location associated with the performance incident.

In one or more embodiments, the method further includes determining, by the at least one processor, using the administration service, at least one message for alerting at least one user of the performance incident based at least in part on the geographic location.

In one or more embodiments, the method further includes where the at least one front-end includes a geographic location.

In one or more embodiments, the method further includes determining, by the at least one processor, using the administration service, at least one language of the at least one message based at least in part on the geographic location of the at least one front-end.

In one or more embodiments, the method further includes: determining, by the at least one processor, at least one application type of the at least one front-end; and modifying, by the at least one processor, the at least one message based at least in part on the at least one application type.

In one or more embodiments, the method further includes: receiving, by the at least one processor, at least one receipt confirmation from the at least one front-end, the at least one receipt confirmation confirm a receipt and a display of the at least one message by the at least one front-end; and updating, by the at least one processor, the user interface of the administrative service to present status confirmation report indicating that the at least one receipt confirmation of the at least one front-end for the at least one message.

In one or more embodiments, the method further includes: receiving, by at least one processor via the particular API of the administration service, an updated performance incident indication indicative of an updated status of the performance incident associated with at least one application service; determining, by the at least one processor, using the administration service, an updated performance incident status based at least in part on the updated performance incident indication; determining, by the at least one processor, using the administration service, at least one updated message including an updated notification of the updated to the performance incident based at least in part on the updated performance incident indication indicative; updating, by the at least one processor, the at least one front-end with the at least one updated message using the at least one front-end specific API call so as to cause the at least one front-end to render the at least one updated message with the front-end specific formatting; updating, by the at least one processor, using the at least one public status page specific adapter of the plurality of adapters of the particular API, the at least one public status page with the at least one updated message using the at least one public status page specific API call so as to cause the at least one public status page to render the at least one updated message with public status page specific formatting; and updating, by the at least one processor, the user interface of the administrative service to present the application status indicating that the at least one front-end is updated with the at least one updated message.

The present disclosure provides one or more embodiments of a non-transitory computer readable medium having software instructions stored thereon for electronic messaging using a network communications architecture. The software instructions are configured to cause at least one processor to perform steps to: receive, via a particular application programming interface (API) of an administration service, a performance incident indication indicative of a performance incident associated with at least one application service; where the performance incident indication includes: an incident type identifier identifying a type of the performance incident and at least one application service identifier identifying the at least one application service; determine, using the administration service, a performance incident status based at least in part on the performance incident indication; determine, using the administration service, at least one message including a notification of the performance incident based at least in part on: the performance incident status and the incident type identifier; determine, using the administration service, at least one front-end associated with the at least one application service; generate, using at least one front-end specific adapter of a plurality of adapters of the particular API, at least one front-end specific API call to the at least one front-end; update, the at least one front-end with the at least one message using the at least one front-end specific API call so as to cause the at least one front-end to render the at least one message with front-end specific formatting; generate, using at least one public status page specific adapter of a plurality of adapters of the particular API, at least one public status page specific API call to at least one public status page; update, using the at least one public status page specific adapter of the plurality of adapters of the particular API, the at least one public status page with the at least one message using the at least one public status page specific API call so as to cause the at least one public status page to render the at least one message with public status page specific formatting; and update a user interface of the administrative service to present an application status indicating that the at least one front-end is updated with the at least one message.

In one or more embodiments, the non-transitory computer readable medium further includes where the performance incident indication includes a geographic location associated with the performance incident.

In one or more embodiments, the non-transitory computer readable medium further includes where the software instructions are further configured to cause the at least one processor to perform steps to determine, using the administration service, at least one message for alerting at least one user of the performance incident based at least in part on the geographic location.

In one or more embodiments, the non-transitory computer readable medium further includes where the at least one front-end includes a geographic location.

In one or more embodiments, the non-transitory computer readable medium further includes where the software instructions are further configured to cause the at least one processor to perform steps to determine, using the administration service, at least one language of the at least one message based at least in part on the geographic location of the at least one front-end.

In one or more embodiments, the non-transitory computer readable medium further includes where the software instructions are further configured to cause the at least one processor to perform steps to: determine least one application type of the at least one front-end; and modify the at least one message based at least in part on the at least one application type.

In one or more embodiments, the non-transitory computer readable medium further includes where the software instructions are further configured to cause the at least one processor to perform steps to determine: receive at least one receipt confirmation from the at least one front-end, the at least one receipt confirmation confirm a receipt and a display of the at least one message by the at least one front-end; and update the user interface of the administrative service to present status confirmation report indicating that the at least one receipt confirmation of the at least one front-end for the at least one message.

In one or more embodiments, the non-transitory computer readable medium further includes where the software instructions are further configured to cause the at least one processor to perform steps to determine: receive, via the particular API of the administration service, an updated performance incident indication indicative of an updated status of the performance incident associated with at least one application service; determine, using the administration service, an updated performance incident status based at least in part on the updated performance incident indication; determine, using the administration service, at least one updated message including an updated notification of the updated to the performance incident based at least in part on the updated performance incident indication indicative; update the at least one front-end with the at least one updated message using the at least one front-end specific API call so as to cause the at least one front-end to render the at least one updated message with the front-end specific formatting; update, using the at least one public status page specific adapter of the plurality of adapters of the particular API, the at least one public status page with the at least one updated message using the at least one public status page specific API call so as to cause the at least one public status page to render the at least one updated message with public status page specific formatting; and update the user interface of the administrative service to present the application status indicating that the at least one front-end is updated with the at least one updated message.

The present disclosure provides one or more embodiments of a system for electronic messaging using a network communications architecture. The system includes: at least one processor in communication with at least one front-end via a network; where the at least one processor is configured to execute software instructions stored on a non-transitory computer readable medium, where the software instructions, upon execution, cause the at least one processor to perform steps to: receive, via a particular application programming interface (API) of an administration service, a performance incident indication indicative of a performance incident associated with at least one application service; where the performance incident indication includes: an incident type identifier identifying a type of the performance incident and at least one application service identifier identifying the at least one application service; determine, using the administration service, a performance incident status based at least in part on the performance incident indication; determine, using the administration service, at least one message including a notification of the performance incident based at least in part on: the performance incident status and the incident type identifier; determine, using the administration service, at least one front-end associated with the at least one application service; generate, using at least one front-end specific adapter of a plurality of adapters of the particular API, at least one front-end specific API call to the at least one front-end; update the at least one front-end with the at least one message using the at least one front-end specific API call so as to cause the at least one front-end to render the at least one message with front-end specific formatting; generate, using at least one public status page specific adapter of a plurality of adapters of the particular API, at least one public status page specific API call to at least one public status page; update, using the at least one public status page specific adapter of the plurality of adapters of the particular API, the at least one public status page with the at least one message using the at least one public status page specific API call so as to cause the at least one public status page to render the at least one message with public status page specific formatting; and update a user interface of the administrative service to present an application status indicating that the at least one front-end is updated with the at least one message.

In one or more embodiments, the system further includes where the software instructions are further configured to cause the at least one processor to perform steps to determine, using the administration service, at least one message for alerting at least one user of the performance incident based at least in part on a geographic location associated with the performance incident.

In one or more embodiments, the system further includes where the software instructions are further configured to cause the at least one processor to perform steps to determine, using the administration service, at least one language of the at least one message based at least in part on a geographic location associated with the at least one front-end.

In one or more embodiments, the system further includes where the software instructions are further configured to cause the at least one processor to perform steps to: receive at least one receipt confirmation from the at least one front-end, the at least one receipt confirmation confirm a receipt and a display of the at least one message by the at least one front-end; and update the user interface of the administrative service to present status confirmation report indicating that the at least one receipt confirmation of the at least one front-end for the at least one message.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 depicts a block diagram of an exemplary computer-based system and platform 100 configured for network communication with electronic messaging, including for selective deployment of system status messages to multiple front-end endpoints in accordance with one or more embodiments of the present disclosure.

FIG. 2 is a block diagram of an administrative service for network communication with electronic messaging, including for selective deployment of system status messages to multiple front-end endpoints in accordance with one or more embodiments of the present disclosure.

FIG. 3A illustrates a block diagram of an illustrative administrative portal 242 and methodology for message generation for administration communication to front-end endpoints in accordance with one or more embodiments of the present disclosure.

FIG. 3B illustrates a block diagram of an illustrative incident reporting service 223 and methodology for message generation for administration communication to front-end endpoints in accordance with one or more embodiments of the present disclosure.

FIG. 4 illustrates a block diagram of an illustrative status API gateway 230 and methodology for messaging and message status tracking adapted for multiple front-end endpoints in accordance with one or more embodiments of the present disclosure.

FIG. 5 depicts a block diagram of another exemplary computer-based system and platform 500 for network communication with electronic messaging, including for selective deployment of system status messages to multiple front-end endpoints in accordance with one or more embodiments of the present disclosure.

FIG. 6 illustrates schematics of exemplary implementations of the cloud computing/architecture(s) in which the server system 105 and administration service 110 of the present disclosure may be specifically configured to operate for network communication with electronic messaging, including for selective deployment of system status messages to multiple front-end endpoints in accordance with one or more embodiments of the present disclosure.

FIG. 7 illustrates schematics of exemplary implementations of the cloud computing/architecture(s) in which the server system 105 and administration service 110 of the present disclosure may be specifically configured to operate for network communication with electronic messaging, including for selective deployment of system status messages to multiple front-end endpoints in accordance with one or more embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

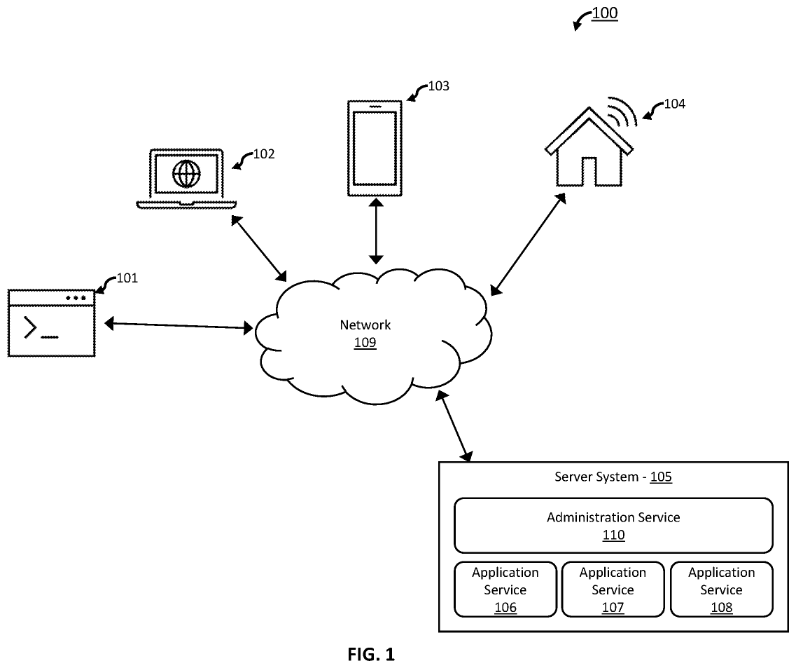

FIGS. 1 through 7 illustrate systems and methods of consistent electronic messaging across a variety of front-end applications and endpoints. The following embodiments provide technical solutions and technical improvements that overcome technical problems, drawbacks and/or deficiencies in the technical fields involving interfacing between back-end and front-end layers of an application stack, and messaging consistency and reliability across the front-end applications of the front-end layer. As explained in more detail, below, technical solutions and technical improvements herein include aspects of improved interfacing technologies and architectures for adaptation of an electronic message to configure the electronic message for each particular front-end and/or location to achieve more reliable and more consistent message delivery and tracking. Based on such technical features, further technical benefits become available to users and operators of these systems and methods. Moreover, various practical applications of the disclosed technology are also described, which provide further practical benefits to users and operators that are also new and useful improvements in the art.

FIG. 1 depicts a block diagram of an exemplary computer-based system and platform 100 configured for network communication with electronic messaging, including for selective deployment of system status messages to multiple front-end endpoints in accordance with one or more embodiments of the present disclosure. Not all of these components may be required to practice one or more embodiments, and variations in the arrangement and type of the components may be made without departing from the spirit or scope of various embodiments of the present disclosure. In some embodiments, the illustrative computing devices and the illustrative computing components of the exemplary computer-based system and platform 100 may be configured to manage a large number of members and concurrent transactions, as detailed herein. In some embodiments, the exemplary computer-based system and platform 100 may be based on a scalable computer and network architecture that incorporates varies strategies for assessing the data, caching, searching, and/or database connection pooling. An example of the scalable architecture is an architecture that is capable of operating multiple servers.

In some embodiments, referring to FIG. 1, a third-party integration front-end 101, a web-based front-end 102, a mobile application-based front-end 103, an Internet-of-Things device 104, among other front-end client devices of the exemplary computer-based system and platform 100 may include virtually any computing device capable of receiving and sending a message over a network (e.g., cloud network or Internet, etc.), such as network 109, to and from another computing device, such as server system 105, each other, and the like. In some embodiments, the server system 105 may provide application functionality to each of the third-party integration front-end 101, the web-based front-end 102, the mobile application-based front-end 103, the Internet-of-Things device 104, among other front-end client devices via application services 106 through 108. However, in some situations, one or more application services 106 through 108 may have impacted performance for which users should be notified. Additionally, in some embodiments, the users may be provided with other communicates regarding the status of the system 105, such as, e.g., new functionality and/or new application services, offers and promotions, changes to policies, among other status updates. Thus, the server system 105 may employ an administrative service 110 to administer consistent and real-time electronic messages to each of the third-party integration front-end 101, the web-based front-end 102, the mobile application-based front-end 103, the Internet-of-Things device 104, among other front-end client devices such that each front-end client device is provided with an adapted message that is specifically formatted and presented for the associated front-end client device. Thus, the administration service 110 may improve the reliability and consistency of message delivery and tracking to the front-end client devices enabling more timely and effective status updates for users.

In some embodiments, the client devices may be personal computers, multiprocessor systems, microprocessor-based or programmable consumer electronics, network PCs, and the like. In some embodiments, one or more member devices within client devices may include computing devices that typically connect using a wireless communications medium such as cell phones, smart phones, pagers, walkie talkies, radio frequency (RF) devices, infrared (IR) devices, citizens band radio, integrated devices combining one or more of the preceding devices, or virtually any mobile computing device, and the like.

In some embodiments, one or more client devices within the third-party integration front-end 101, web-based front-end 102, mobile application-based front-end 103, Internet-of-Things device 104 or other client devices may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, OFDM, OFDMA, LTE, satellite, ZigBee, etc.).

In some embodiments, one or more client devices within the third-party integration front-end 101, web-based front-end 102, mobile application-based front-end 103, Internet-of-Things device 104 or other client devices may include one or more applications, such as Internet browsers, mobile applications, voice calls, video games, videoconferencing, and email, among others.

In some embodiments, one or more client devices within the third-party integration front-end 101, web-based front-end 102, mobile application-based front-end 103, Internet-of-Things device 104 or other client devices may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like.

In some embodiments, one or more client devices within the third-party integration front-end 101, web-based front-end 102, mobile application-based front-end 103, Internet-of-Things device 104 or other client devices may be specifically programmed by either Java, .Net, QT, C, C++, Python, PHP and/or other suitable programming language. In some embodiment of the device software, device control may be distributed between multiple standalone applications. In some embodiments, software components/applications can be updated and redeployed remotely as individual units or as a full software suite. In some embodiments, a member device may periodically report status or send alerts over text or email.

In some embodiments, a client device may contain a data recorder which is remotely downloadable by the user using network protocols such as FTP, SSH, or other file transfer mechanisms. In some embodiments, a member device may provide several levels of user interface, for example, advance user, standard user.

In some embodiments, one or more client devices within the third-party integration front-end 101, web-based front-end 102, mobile application-based front-end 103, Internet-of-Things device 104 or other client devices may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 109 may provide network access, data transport and/or other services to any computing device coupled to it. In some embodiments, the exemplary network 109 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 109 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 109 may include and implement, as an alternative or in conjunction with one or more of the above, a WiMAX architecture defined by the WiMAX forum. In some embodiments and, optionally, in combination of any embodiment described above or below, the exemplary network 109 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 109 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, OFDM, OFDMA, LTE, satellite and any combination thereof. In some embodiments, the exemplary network 109 may also include mass storage, such as network attached storage (NAS), a storage area network (SAN), a content delivery network (CDN) or other forms of computer or machine readable media.

In some embodiments, the server system 105 may be a web server (or a series of servers) running a network operating system, examples of which may include but are not limited to Apache on Linux or Microsoft IIS (Internet Information Services). In some embodiments, the server system 105 may be used for and/or provide cloud and/or network computing. Although not shown in FIG. 1, in some embodiments, the server system 105 may have connections to external systems like email, SMS messaging, text messaging, ad content providers, etc.

In some embodiments, the server system 105 may employ one or more application services 106 through 108 to provide functionality over the network 109 to one or more client devices within the third-party integration front-end 101, web-based front-end 102, mobile application-based front-end 103, Internet-of-Things device 104 or other client devices. In some embodiments, the server system 105 may utilize an administration service 110 to monitor and track performance, errors, faults, anomalies, outages, or any other incidents associated with the application service 106, the application service 107, the application service 108 or other application service or other service or any combination thereof. Based on the performance, errors, faults, anomalies, outages or any other incidents, the administration service 110 may be configured to provide an administrative (admin) portal to managing the performance, errors, faults, anomalies, outages, or any other incidents. In some embodiments, the admin portal may provide for the selection of messages, application programming interface (API) access to push the messages concerning the performance, errors, faults, anomalies, outages, or any other incidents, and maintain a public status page with updates regarding the current status of each application service 106 through 108 with respect to performance, errors, faults, anomalies, outages, or any other incidents.

In some embodiments, the term “application programming interface” or “API” refers to a computing interface that defines interactions between multiple software intermediaries. An “application programming interface” or “API” defines the kinds of calls or requests that can be made, how to make the calls, the data formats that should be used, the conventions to follow, among other requirements and constraints.

In some embodiments, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, the server system 105 may be specifically programmed to perform, in non-limiting example, as authentication servers, search servers, email servers, social networking services servers, Short Message Service (SMS) servers, Instant Messaging (IM) servers, Multimedia Messaging Service (MMS) servers, exchange servers, photo-sharing services servers, advertisement providing servers, financial/banking-related services servers, travel services servers, or any similarly suitable service-base servers for users of the client devices 101-104.

In some embodiments and, optionally, in combination of any embodiment described above or below, for example, one or more of the client devices 101-104 and the server system 105 may include a specifically programmed software module that may be configured to send, process, and receive information using a scripting language, a remote procedure call, an email, a tweet, Short Message Service (SMS), Multimedia Message Service (MMS), instant messaging (IM), an application programming interface, Simple Object Access Protocol (SOAP) methods, Common Object Request Broker Architecture (CORBA), HTTP (Hypertext Transfer Protocol), REST (Representational State Transfer), SOAP (Simple Object Transfer Protocol), MLLP (Minimum Lower Layer Protocol), or any combination thereof.

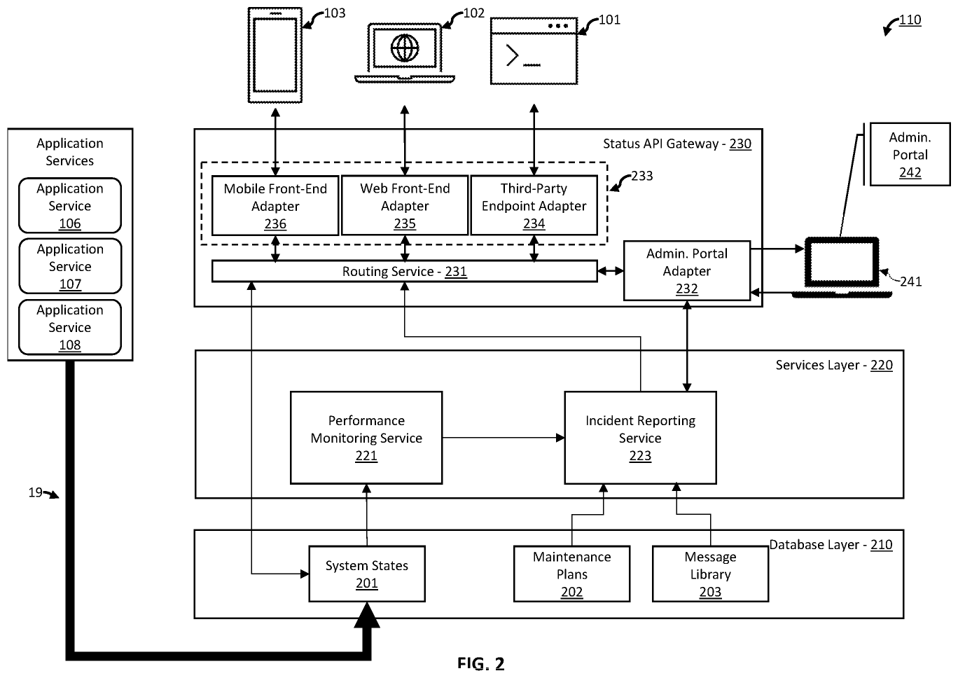

FIG. 2 is a block diagram of an administrative service for network communication with electronic messaging, including for selective deployment of system status messages to multiple front-end endpoints in accordance with one or more embodiments of the present disclosure.

In some embodiments, the server system 105 may communicate with the front-end clients 101 through 104 regarding status and/or operations of the server system 105 including, e.g., the application services 106 through 108 as well as other information related to the server system 105. Typically, a server system, such as a cloud platform or other centralized or decentralized system may be limited to individual messages specific to each front-end client and/or social media posts and press releases. In some embodiments, to improve the communication efficiency and consistency between the server system 105 and the front-end clients, the server system 105 may employ the administration service 110 to administer single message status updates across the front-end clients, including formatting and adapting the single message for each front-end client and enabling automatic routing and tracking of the message across the front-end clients.

In some embodiments, the administration service 110 may include a server and/or cloud stack that includes a database layer 210, a services layer 220 and a status API gateway 230 to interface with the third-party integration front-end 101, web-based front-end 102, mobile application-based front-end 103. In some embodiments, the administration service 110 may be in communication with one or more application services 106 through 108 of the server system 105, as described above. The administration service 110 may employ the database layer 210, the services layer 220 and the status API gateway 230 to monitor application service statuses, including performance status and performance impacts such as anomalies, outages, communication errors, network errors, processing errors, configuration errors, malware detection, detected attacks, among other incidents that signal and/or cause a performance incident in one or more of the application services 106 through 108.

In some embodiments, the database layer 210 may log system states 201 from a data feed of performance-related data, such as, e.g., network traffic, debug logs, process and task histories, operation and task metrics, throughput, bandwidth, error logs, memory use, processor utilization, virtual machine scheduling, task scheduling, among other performance-related data or any combination thereof. In some embodiments, the application services 106 through 108 may provide the performance-related data by a data pipeline 19. In some embodiments, the raw data is updated on a periodic batch basis, such as, e.g., hourly, daily, weekly, or by any other suitable batch period. In some embodiments, the data feed provides data via the data pipeline 19 on a continuous basis, such as, in real-time. Thus, the performance-related data may form a time-varying set of data. The data pipeline 19 may transform, standardize, and/or organize the data and communicate the transformed, standardized, and/or organized data to the system states 201 in the database layer 210 for storage. In embodiments, the data pipeline 19 may transform, standardize, and/or organize the data into a time-series format.

In embodiments, one or more users may monitor or otherwise access the data to diagnose behaviors of devices and systems associated with the data, such as upstream sensors, data collection systems, and data transformation pipelines. However, viewing many facets of the data, such as hundreds, thousands, tens of thousands, hundreds of thousands, even millions, or more of the combinations of variables and dimensions, which may include time, does not lend towards efficient interpretability. Thus, in embodiments, the services layer 220 may include a performance monitoring service 221 that communicates with the system states 201 to detect incidents that impact the performance of the application services 106 through 108. Alternatively, or additionally, the data pipeline 19 may provide the raw data directly to the performance monitoring service 221.

In some embodiments, the performance monitoring service 221 may detect the incidents based on characteristics of the transformed, standardized, and/or organized performance-related data stored in the system states 201. In some embodiments, the performance monitoring service 221 may utilize one or more rules-based and/or machine learning-based algorithms to interpret the performance-related data and identify an incident.

For example, in some embodiments, the performance monitoring service 221 may employ, e.g., a detection model or ensemble of detection models. The detection model(s) may utilize one or more detection methodologies to discover data points within the data in the system states 201 that are indicative of an incident, such as an anomalies, a hardware and/or software outage, a communication error, a network error, a processing error, a configuration error, a malware attack, an exploit, among other incidents that signal and/or cause a performance incident in one or more of the application services 106 through 108. In some embodiments, to most accurately and efficiently discover the events, the detection model is an ensemble model that employs multiple detection methodologies. However, in other embodiments, to improve simplicity and reduce resources, a single detection model with one detection methodology is employed.

In an embodiment, the performance monitoring service 221 may create an incident report for each incident. In some embodiments, the incident report represents a record of the performance-related data that indicates the detected incident as well as identifying data, such as, e.g., the associated application service 106 through 108, a date of the incident, a time of the incident, a location of affected hardware, among other data or any combination thereof.

In some embodiments, the administrative service 110 may be made more efficient by outsourcing the performance monitoring and incident detection. A separate service of the server system 105 and/or an infrastructure layer may include performance monitoring and incident reporting. Thus, to avoid duplication of processing and thus increase the efficiency of the server system 105, the administrative service 110 may receive incident records via the data pipeline 19 from a separate and/or remote performance monitoring service 221. Accordingly, in some embodiments, the system states 201 may store the received incident records as indicative of states of performance incidents in the server system 105. Thus, the performance monitoring service 221 may be omitted.

In some embodiments, when incidents occur that impact the application services 106 through 108, front-end applications, such as webpages, mobile application, third-party integration, among other front-end endpoints may experience degraded service. Such degraded service may impede certain application functionalities, cause a loss of data, violate service level agreement(s), among other effects to a user. Accordingly, notifying users of incidents that may effect the front-end(s) associated with each user allows the users to plan around the effects. However, typically, such notifications are limited to social media posts, press releases, and publicly accessible portals to view status updates for the application services 106 through 108. These solutions require multiple discrete messages via each medium. Thus, the administration service 110 may improve the messaging solutions to provide front-end notifications by using a status API gateway 230 architected to route and format a message specifically for each particular endpoint affected by a particular incident. The status API gateway 230 may use messages generated by an incident reporting service 223 and administrative portal 242 to issue specifically routed and formatted versions of the message, thus decreasing the number of messages that need to be produced and providing improved electronic communications between the server system 105 and the front-end clients.

In some embodiments, to create the message, the incident reporting service 223 may access or otherwise receive an incident record from the performance monitoring service 221 and/or from the system states 201. In some embodiments, the incident record may include attributes of the incident such as, e.g., an incident type (e.g., network error, configuration error, security threat, bandwidth limitation, software error, etc.), incident reach (e.g., affected servers and locations thereof), application(s) associated with the affected application service, severity (e.g., performance impact and/or service outage), among other attributes or any combination thereof.

In some embodiments, the incident record may include a planned maintenance event. Such planned maintenance events may include modifications to server system 105 infrastructure and/or software, such as, e.g., installing new firmware and/or software, deploying new configurations, migrating to new databases, integrating new computing hardware, among other maintenance events or any combination thereof. As a result, the planned maintenance events may result in performance degradation and/or service outage lasting a particular period of time. Accordingly, the database layer 210 may include a log of maintenance plans 202 having a multiple planned maintenance event records. In some embodiments, a planned maintenance event record may include a performance incident indication indicating the incident. The performance incident indication may include attributes such as, e.g., e.g., a maintenance caused effects type (e.g., network error, configuration error, security threat, bandwidth limitation, software error, etc.), maintenance caused effects reach (e.g., affected servers and locations thereof), application(s) associated with the planned maintenance event, severity (e.g., performance impact and/or service outage), among other attributes or any combination thereof.

In some embodiments, the attributes of the performance incident indication may need to be communicated to affected users to notify the affected users. Thus, the incident reporting service 223 may generate a message that communicates the information represented by the attributes. In some embodiments, the message may be generated automatically based on template messages in a message library 203 or algorithmically in response to the attributes of the incident record, or any combination thereof.

In some embodiments, the incident reporting service 223 may access a library of message templates in the message library 203 and identify a message template associated with the incident record and/or the maintenance event record. In some embodiments, each message template may include one or more fields for, e.g., the incident type, an expected time period of the performance degradation and/or service outage, an application service affected, affected applications and/or Internet-of-Things devices, among other information characterizing the status of the incident and/or planned maintenance event. In some embodiments, the message template may include pre-filled fields, where each combination of incident record attributes and/or maintenance event record attributes match to a particular message having a particular combination of pre-filled fields based on each combination of incident record attributes and/or maintenance event record attributes.

In some embodiments, to reduce the storage requirements, and thus improve the resource efficiency of the database layer 210, the message templates may include unfilled fields. In some embodiments, all fields of each message template may be unfilled, some fields of each message template may be unfilled, or all or some of some message templates may be unfilled, or any suitable combination thereof. In some embodiments, the incident reporting service 223 may automatically populate the unfilled fields of the message template of the incident record and/or maintenance event record.

In some embodiments, the incident reporting service 233 may match attributes of the performance indication to unfilled fields in the message. For example, an incident type identifier of the performance indication may be matched to an incident type field of the message, and the incident reporting service 233 may then populate the incident type field with the attribute of the incident type identifier to specify the incident type in the message. Similarly, the incident reporting service 233 may fill, e.g., incident time period, incident start date, incident end date, incident severity, affected application server, affected application, affected IoT device(s), geographic location of the affected application server, geographic location of the affected application(s) and/or front-end(s) and/or IoT device(s), etc. using the respective identifiers in the performance indication and the respective fields of the message.

In some embodiments, the incident reporting service 223 may determine one or more of the attributes of the performance incident indication based on one or more other attributes. For example, the incident reporting service 223 may determine an incident time period based on the incident type and/or the affected application service. Similarly, the incident reporting service 223 may determine an affected application or affected front-end based on the affect application service and/or the incident type. As a result, the incident reporting service 233 may fill fields even where one or more attributes have not been identified a priori.

In some embodiments, the incident may be an update to a status of a pre-existing performance incident. The incident reporting service 233 may periodically update the status of a performance incident after generating an associated message. For example, the severity and/or reach of the performance incident may change through time, or the time period of the performance incident may change based on new information. Accordingly, the incident reporting service 223 may receive a status update, e.g., via the system states 201, the performance monitoring service 221 or other mechanism with an updated incident record and/or planned maintenance record having a performance incident indication with updated attributes. In some embodiments, the incident reporting service 223 may generate a new message or modify the original message of the performance incident to populate the fields thereof with the updated attributes. Thus, the incident reporting service 223 may periodically and/or on command generate new messages with updated attributes for a performance incident as the performance incident evolves.

In some embodiments, the incident reporting service 223 may interact with an administration (“admin”) portal 202 via an admin portal adapter 232 of a status API gateway 230. The admin portal adapter 232 enables the admin portal 242 as an admin computing device 241 to interact with the services layer 220 in a consistent and reliable manner over a network. In some embodiments, the admin portal adapter 232 enables particular administrative permissions for the admin computing device 241, such as, e.g., permissions to read, write and/or create messages for performance incidents, e.g., based on incident records, planned maintenance records and/or without an incident record or planned maintenance record. Thus, the admin portal adapter 232 of the status API gateway 230 enables an administrative user to interface with the incident reporting service 223 to define messages and/or fields of messages to notify users of performance incidents and statuses thereof.

In some embodiments, the administrative user may use the admin portal 242 to access a message accessed by the incident reporting service 223 form the message library 203. In some embodiments, the admin portal 242 may include a message selection interface element for user selection of the message template to be accessed in the message library. In some embodiments, the incident reporting service 223 may suggest a message template matching the incident type, and the user may employ the message selection interface element to change or correct the suggested message template. In some embodiments, the administrative user may use the message selection interface element prior to the incident reporting service 223 accessing a message template as a way to instruct the incident reporting service 223 to access a particular selected message template.

The administrative user may select one or more user input interface elements of the admin portal 242 to interface with the new message, e.g., by providing user input to one or more fields of the new message. In some embodiments, the user input interface elements may include free form test input, a list selection element, a radio button selection element, a calendar date selection element, or any other suitable user input interface element or any combination thereof. In some embodiments, the admin portal 242 may include a user input interface element for each field of the new message for manual population of the new message. In some embodiments, manual population and automated population may be mixed. For example, the admin portal 242 may include user input interface elements for user input of attributes, such as, e.g., an incident type, time period, start date, etc. Based on the user input, the incident reporting service 223 may auto-populate the remaining fields using the techniques described above.

In some embodiments, the message may include a previously populated and sent message for an existing or previous performance incident. The administrative user may access the message via the admin portal 242 to change the attributes populating the fields of message, e.g., to update a status of the associated performance incident. For example, the administrative user change the affected application services, the affected applications, the affected locations, the end date, the time period, the severity, or other attributes based on changes to the performance incident.

In some embodiments, upon the fields of the message being populated, the incident reporting service 223 may instruct the status API gateway 230 to send the message to the appropriate front-ends. In some embodiments, the instruction to send the message may be triggered by user confirmation via the admin portal 242, automatically upon completion of all fields in the message, or by any other suitable mechanism or any combination thereof.

In some embodiments, the message with the performance indication and attributes thereof may be provided to the status API gateway 230. In some embodiments, the performance incident may affect certain front-end applications and/or certain geographic locations. Sending the message to unaffected front-ends and/or locations results in unnecessary processing and network traffic. Accordingly, the status API gateway 230 may employ a routing service 231 to initiate one or more routes for the message such that the affected front-ends at the affected locations are provided with the message.

In some embodiments, the routing service 231 may receive the message from the incident reporting service 223 and/or form the admin portal adapter 232. In some embodiments, the message may be provided with the incident record/planned maintenance record and/or the attributes of the incident record/planned maintenance record. In some embodiments, to determine which front-end to which to direct the message, the routing service 231 may identify the incident type and/or affected application service and/or affected front-end using the attributes. In some embodiments, the routing service 231 is connected to multiple adapters, including one or more mobile front-end adapters 236, one or more web front-end adapters 235, one or more third-party endpoint adapters 234, or among others or any combination thereof.

Each adapter interfaces with a particular endpoint, such as a webpage, a mobile application, third-party integrations, or any other suitable endpoints. Moreover, each adapter may be associated with a particular application and/or functionality, such as, e.g., a first party smart home application, a third-party smart home application, a particular IoT device application and/or plug-in, a software application enabled by a particular application service, or any other suitable endpoint software and/or functionality. Each endpoint, endpoint software and/or endpoint functionality may use different front-end architectures including, e.g., display formats, information structuring methodologies, capabilities, user interaction mechanisms (e.g., user interface and interface elements), permissions, communication and/or messaging technologies, transfer protocols, among other variations. Thus, each adapter is configured to communicate information between the status API gateway 230 and the associated endpoint using the particular front-end architecture of the associated endpoint.

In some embodiments, the routing service 231 may use the attributes to determine the applications affected by the performance incident. Such determination may include identifying the application and geographic locations affected based on the incident type, affected geographic location, affected application, affected application service or any combination thereof. The attributes may be correlated to a particular application and/or functionality and/or location, which is associated with a particular endpoint or endpoints. For example, the routing service 231 may include, e.g., a routing table or other suitable data structure that maps application services and/or locations to endpoints. Thus, the routing service 231 identifies the endpoints associated with the performance incident based on the attributes.

In some embodiments, based on the identified endpoints, the routing service 231 may engage and/or instruct adapters 233 associated with each identified endpoint. In some embodiments, by employing multiple adapters 233, the status API gateway 230 can expose a different API for each endpoint and thus the status API gateway 230 may serve as a single entry point for all endpoints. The status API gateway 230 may handle requests in two directions, routing requests from the endpoints to the appropriate service, and from services to the appropriate endpoint. As such, the status API gateway 230 may reduce the number of requests/roundtrips. For example, the API gateway enables clients to retrieve data from multiple services with a single round-trip. Fewer requests also means less overhead and improves the user experience. In some embodiments, the status API gateway 230 may also implement security, e.g., verify that the client is authorized to perform the request.

In some embodiments, the mobile front-end adapter 236 may interface with the mobile application front-end 103, the web front-end adapter 235 may interface with the web-based front-end 102 and the third-party endpoint adapter 234 may interface with third-party integrations, such as third-party applications and webpages that access data from the application services. Accordingly, the status API gateway 230 provides front-end specific API calls via the adapters 233 for each front-end endpoint.

In some embodiments, interfacing with a front-end may include exchanging API calls or other communications prior to sending the message. For example, when a device loads a mobile application associated with an application service 106 through 108, the mobile application may connect with the associated application service 106 through 108, including issuing an API call to the status API gateway 230 based on software instructions of the mobile application. The API call may include a request to the mobile front-end adapter 236 for any status updates for the mobile application. The request may include mobile application data such as, e.g., IP address, global positioning system (GPS) location, default or selected language, user account, IoT devices registered with the mobile application, IoT devices registered with the user account, among other mobile application data or any combination thereof. Similarly, a webpage upon loading may issue an API call to the status API gateway 230 with a request to the web front-end adapter 235 including, e.g., IP address, global positioning system (GPS) location, default or selected language, user account, IoT devices registered with the web application, IoT devices registered with the user account, among other web application data or any combination thereof. Similarly, a third-party application/webpage having third-party integrations, upon loading, may issue an API call to the status API gateway 230 with a request to the third-party front-end adapter 234 including, e.g., IP address, GPS location, default or selected language, user account, IoT devices registered with the third-party application, IoT devices registered with the user account, among other third-party application data or any combination thereof. Thus, the adapters 233 may store data for each endpoint, including each mobile application front-end 103, each web-based front-end 102 and each third-party integration front-end 101 for device-specific data including, e.g., IP address, GPS location, default or selected language, user account, IoT devices registered with the endpoint instance, IoT devices registered with the user account, among other endpoint instance data or any combination thereof.

In some embodiments, upon being instructed to send the message to one or more endpoints, the adapter 233 may cache the message in one or more message queues for sending in response to a request from an associated endpoint. In some embodiments, each adapter 233 may have an adapter-specific message queue. Alternatively, or in addition, the routing service 231 or the adapters 233 may include a shared message queue that queues messages for all adapters 233. In some embodiments, the routing service 231 and/or adapters 233 may include any suitable combination of shared and adapter-specific message queues to optimize processor, time, and memory efficiency.

In some embodiments, the instructed/engaged adapters 233 may each receive the message from the routing service 231 and format the message according to the front-end specific API call. In some embodiments, the front-end specific API call may be location specific. For example, the attribute for an affected geographic location may be associated with endpoint instances (e.g., particular devices on which the front-end is instantiated and/or rendered) in the affected geographic location, e.g., based on internet protocol (IP) address of particular devices of each endpoint instance, location reporting by the endpoint instances, or by any other suitable location determination technique or any suitable combination thereof.

In some embodiments, the adapters 233 may include logic for formatting the message for particular endpoint instances and/or locations. In some embodiments, prior to queuing the message and/or prior to sending the message, each adapter 233 may identify, for example, the geographic location and/or language setting of particular endpoint instances, e.g., based on internet protocol (IP) address of particular devices of each endpoint instance, location reporting by the endpoint instances, or by any other suitable location determination technique or any suitable combination thereof. Based on the geographic location and/or language setting, the adapters 233 may determine a language associated with the endpoint instances and automatically translate the message into the language. In some embodiments, to translate the message, the adapters 233 may include, e.g., one or more translation machine learning models (e.g., utilizing natural language processing (NLP) or other translation models or any combination thereof), one or more language specific message reproductions from a library of language specific message reproductions of the message template associated with the message, or by another other suitable translation technique or any combination thereof.

In some embodiments, the adapters 233 may each include logic for performing any other suitable endpoint instance-specific modifications to the message to adapt the message to the particular endpoints and/or endpoint instances affected by the performance incident. In some embodiments, the modifications may be made based on, e.g., an application type of each endpoint and/or endpoint instance, IP address, GPS location, default or selected language, user account data, IoT devices registered with the mobile application, IoT devices registered with the user account, among other endpoint instance data or any combination thereof.

In some embodiments, the adapters 233 may make endpoint instance-specific modifications based on device type. The adapters 233 may be configured to target messages to endpoint instances that have a device of the device type associated therewith. For example, the performance incident may affect devices, e.g., IoT devices, of a particular type. The adapters 233 may identify the endpoint instances that report or are otherwise registered to be associated with one or more devices of the device type.

In some embodiments, the adapters 233 may make endpoint instance-specific modifications based on geography. The adapters 233 may be configured to target messages to endpoint instances that are in a particular location, and/or may modify the messages based on the particular location. For example, the performance incident may affect one or more particular locations. The adapters 233 may identify the endpoint instances that report or are otherwise registered to be associated with the particular location. Additionally or alternatively, the adapters 233 may modify, e.g., the language, support contact information, among other contextual data based on the location associated with each endpoint instance.

In some embodiments, the web-based front-end 102 may include a public status page that is publicly accessible. In some embodiments, the public status page may include a web front-end adapter 235 that provides read-only data to the web-based front-end 102 concerning every performance incident record and/or every planned maintenance record. Thus, the public status page may provide a real-time status page that is global to the application services and/or the server system 105. In some embodiments, the public status page may be regularly and/or continuously updated with data, via the web front-end adapter 235, to provide performance impact updates for each performance impact. Data may include, e.g., a history of events (e.g., performance incidents and other events related thereto), root cause analysis, links to and/or information for customer care/support, a global status overview of some or all systems and/or applications, among other data or any combination thereof.

In some embodiments, upon connecting with each affected endpoint instance, the respective adapters 233 may transmit the endpoint-specific message having the endpoint instance-specific modifications to each affected endpoint instance. As a result, the message may be communicated to a variety of endpoints, including mobile applications, web application, third-party integrations, and others, in an efficient, uniform, and consistent manner.

In some embodiments, each endpoint may include a graphical user interface configured to render the message as a status update. In some embodiments, the status update may include, e.g., a pop-up, a banner, a push notification, a direct message, or other suitable interface element(s) for displaying the message to a user. In some embodiments, the status update may include interface element(s) for user interaction, such as a confirm element, a cancel element, a delete element, a remind later element, or other suitable user interactive element. In some embodiments, upon the user selecting a user interactive element of the status update, the selection may be logged and returned to the status API gateway 230 via the endpoint-specific API call to the adapters 233.

In response, each endpoint instance may be configured to return an acknowledgement that confirms receipt of the message via the associated endpoint-specific API call to the adapters 233. In some embodiments, the adapters 233 may return the acknowledgment and any user interactions from each endpoint instance to the system states 201 and/or the admin portal adapter 232, e.g., via the routing service 231 or directly.

In some embodiments, the admin portal adapter 232 may interface with the administrative computing device 201 to update the admin portal 242 with the acknowledgement and/or user interactions by accessing the system states 201 and/or receiving the acknowledgement and/or user interactions from each adapter 233. In some embodiments, the admin portal 242 may update a record associated with each message, such as a message record, the performance incident record and/or the planned maintenance record with data regarding user receipt and/or user response. Accordingly, the admin portal 242 may aggregate and monitor user activity statistics with respect to each message to determine the efficacy and performance of each message.

In some embodiments, as described above, the incident reporting service 223 and/or an administrative user of the admin portal 242 may, periodically or in response to a change in a performance incident, update a status of the performance incident. For example, throughout the lifetime of a performance incident, the affected application services, the affected applications, the affected locations, the end date, the time period, the severity, or other attributes may change as a result of, e.g., progress of maintenance, integration, and deployment of fixed and configurations, additional errors and/or incidents, among other factors. In some embodiments, such changes may be provided by the application services via the data pipeline 19 to the system states 201. The performance monitoring service 221 may detect the changes and update the performance incident report and/or the planned maintenance report. In some embodiments, according to a similar process described above, the incident reporting service 223 and/or the admin portal 242 may update the associated message and instruct the status API gateway 230 to send the updated message to the affected front-end endpoints. In some embodiments, the updated messages may generate and/or sent on a periodic or real-time basis to provide updated notifications regarding the performance incident to affected users. In some embodiments, as acknowledgements and/or user interactions are received in response to the updated message, the admin portal 242 may be updated as described above.

As a result, the status API gateway 230 and admin portal 242 enable regular, consistent, and efficient status updates for users affected by performance issues. While described above are embodiments in the context of performance incidents, similar messaging methodologies with the status API gateway 230 and admin portal 242 may be employed for other types of status updates, such as, e.g., press releases, advertisements, status of new feature and service developments, among other user outreach messaging.

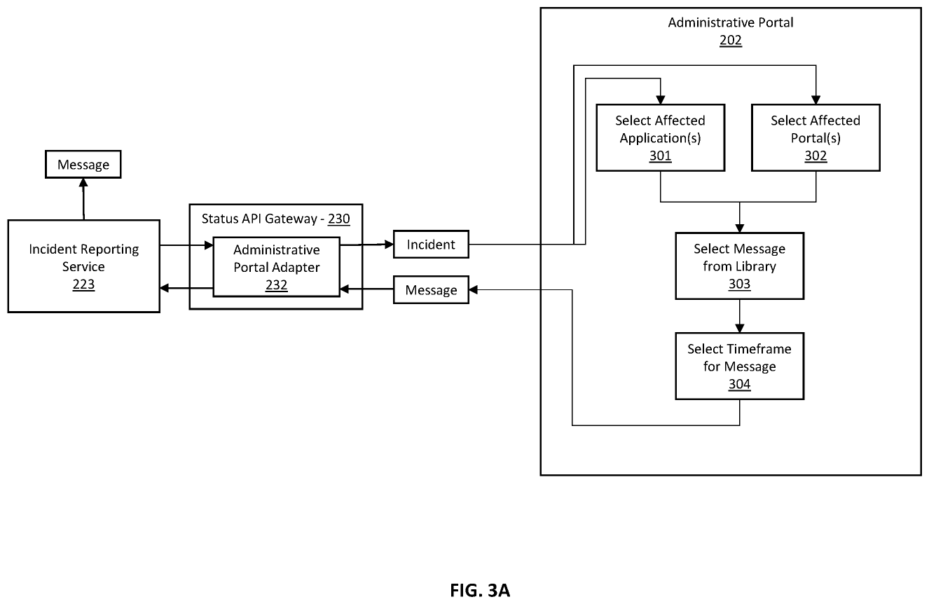

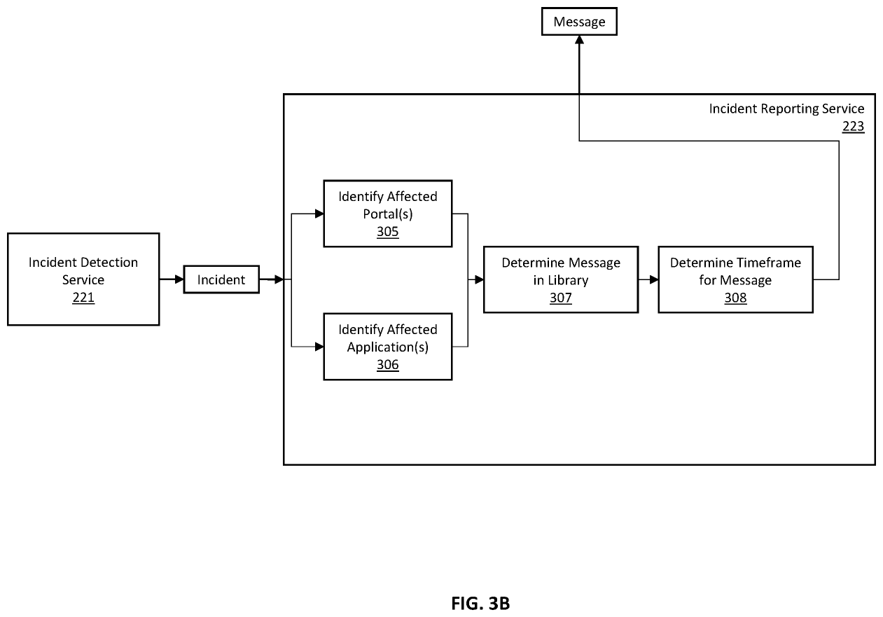

FIG. 3A illustrates a block diagram of an illustrative administrative portal 242 and methodology for message generation for administration communication to front-end endpoints in accordance with one or more embodiments of the present disclosure.

In some embodiments, the incident reporting service 223 may provide an incident report (e.g., a performance incident report and/or planned maintenance report) to the status API gateway 230 for delivery to the administrative portal 242. Using the administrative portal adapter 232, the status API gateway 230 may route and structure the incident report specifically for the administrative portal 242. Accordingly, the administrative portal 242 may receive an interactive incident report with administrative privileges such that an administrative user may define the fields of a message based on the incident report.

In some embodiments, at step 301, the user may select one or more affected application(s). In some embodiments, based on the affected application servers and/or the incident type, the administrative user may identify software applications, such as particular software properties, third-party integrations, or other software, affected by the performance incident. Accordingly, the administrative user may interact with a user selectable user interface element of the administrative portal 242 to select the affected application(s).

In some embodiments, similarly at block 302, the user may select one or more affected portal(s). In some embodiments, based on the affected application servers and/or the incident type, the administrative user may identify front-end portals, such as mobile applications and/or web applications, affected by the performance incident.

In some embodiments, at step 303, based on the attributes of the performance incident, the user may select a message that is description of the performance incident. For example, the message may include a description of the type of performance incident, a description of the severity and reach, a time period and/or start and/or end dates, among other information pertinent to the users affected. As a result, the administrative portal may generate a message for the affected application(s) and portal(s).

In some embodiments, the administrative user may select a timeframe for the message at block 304. In some embodiments, the timeframe may specify information to enter into a field in the message or may include an expiration time for the message where the timeframe elapsing causes the message to disappear from endpoint instances. In some embodiments, the timeframe may correspond to a projected duration of the performance incident, e.g., based on the attributes of the performance incident report and/or planned maintenance report, such as, e.g., the start date, end date, time period, incident type, etc.

In some embodiments, the admin portal 242 may return the message based on the administrative user selections of steps 301 through 304 to the administrative portal adapter 232. In some embodiments, the administrative portal adapter 232 may provide the message to the incident reporting service 223, which may send the message to the routing service 231 for routing to the associated endpoints and endpoint instances.

FIG. 3B illustrates a block diagram of an illustrative incident reporting service 223 and methodology for message generation for administration communication to front-end endpoints in accordance with one or more embodiments of the present disclosure.

In some embodiments, the incident reporting service 223 may automatically generate a message in response to a performance incident. Accordingly, the performance monitoring service 221 may provide the performance incident (e.g., the performance incident report and/or planned maintenance report) to the incident reporting service 223. In some embodiments, the performance incident may trigger the incident reporting service 223 to generate the message, including filling fields of the message to describe the attributes of the performance incident.

In some embodiments, at block 305, the incident reporting service 223 may identify one or more affected application(s). In some embodiments, based on the affected application servers and/or the incident type, the incident reporting service 223 may identify software applications, such as particular software properties, third-party integrations, or other software, affected by the performance incident.

In some embodiments, similarly at block 306, the incident reporting service 223 may identify one or more affected portal(s). In some embodiments, based on the affected application servers and/or the incident type, the incident reporting service 223 may identify front-end portals, such as mobile applications and/or web applications, affected by the performance incident.

In some embodiments, at step 307, based on the attributes of the performance incident, the incident reporting service 223 may determine a message in the message library 203 that is description of the performance incident. For example, the incident reporting service 223 may match an incident type, affected application service and/or affected application to a message template. In some embodiments, the message template may include a description of the type of performance incident, a description of the severity and reach, a time period and/or start and/or end dates, among other information pertinent to the users affected.

In some embodiments, the incident reporting service 223 may determine a timeframe for the message at block 308. In some embodiments, the timeframe may specify information to enter into a field in the message or may include an expiration time for the message where the timeframe elapsing causes the message to disappear from endpoint instances. In some embodiments, the timeframe may correspond to a projected duration of the performance incident, e.g., based on the attributes of the performance incident report and/or planned maintenance report, such as, e.g., the start date, end date, time period, incident type, etc.

In some embodiments, the incident reporting service 223 may provide the message to the to the routing service 231 of the status API gateway 230 for routing to the associated endpoints and endpoint instances.

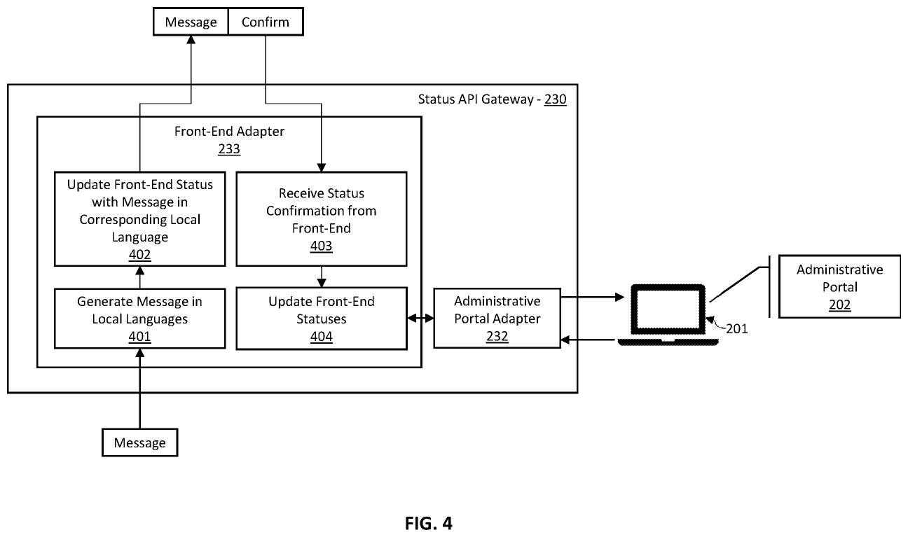

FIG. 4 illustrates a block diagram of an illustrative status API gateway 230 and methodology for messaging and message status tracking adapted for multiple front-end endpoints in accordance with one or more embodiments of the present disclosure.

In some embodiments, the routing service 231 may receive a message from the incident reporting service 223 and/or from the admin portal adapter 232. In some embodiments, the message may be provided with the incident record/planned maintenance record and/or the attributes of the incident record/planned maintenance record. In some embodiments, to determine which front-end to which to direct the message, the routing service 231 may identify the incident type and/or affected application service and/or affected front-end using the attributes. In some embodiments, the routing service 231 is connected to multiple adapters, including one or more mobile front-end adapters 236, one or more web front-end adapters 235, one or more third-party endpoint adapters 234, or among others or any combination thereof.

In some embodiments, based on the identified endpoints, the routing service 231 may engage and/or instruct a front-end adapter 233 associated with each identified endpoint. In some embodiments, by employing multiple front-end adapter 233, the status API gateway 230 can expose a different API for each endpoint and thus the status API gateway 230 may serve as a single entry point for all endpoints. The status API gateway 230 may handle requests in two directions, routing requests from the endpoints to the appropriate service, and from services to the appropriate endpoint. As such, the status API gateway 230 may reduce the number of requests/roundtrips. For example, the API gateway enables clients to retrieve data from multiple services with a single round-trip. Fewer requests also means less overhead and improves the user experience. In some embodiments, the status API gateway 230 may also implement security, e.g., verify that the client is authorized to perform the request.

In some embodiments, the front-end adapter 233 may receive the message from the routing service 231 and format the message according to the front-end specific API call. In some embodiments, the front-end specific API call may be location specific. For example, the attribute for an affected geographic location may be associated with endpoint instances (e.g., particular devices on which the front-end is instantiated and/or rendered) in the affected geographic location, e.g., based on internet protocol (IP) address of particular devices of each endpoint instance, location reporting by the endpoint instances, or by any other suitable location determination technique or any suitable combination thereof.

In some embodiments, the front-end adapter 233 may include logic for formatting the message for particular endpoint instances and/or locations. In some embodiments, prior to queuing the message and/or prior to sending the message, each adapter 233 may identify, for example, the geographic location and/or language setting of particular endpoint instances, e.g., based on internet protocol (IP) address of particular devices of each endpoint instance, location reporting by the endpoint instances, or by any other suitable location determination technique or any suitable combination thereof.

Based on the geographic location and/or language setting, the front-end adapter 233 may, at step 401, determine a local language associated with the endpoint instances and automatically translate the message into the local language. In some embodiments, to translate the message, the front-end adapter 233 may include, e.g., one or more translation machine learning models (e.g., utilizing natural language processing (NLP) or other translation models or any combination thereof), one or more language specific message reproductions from a library of language specific message reproductions of the message template associated with the message, or by another other suitable translation technique or any combination thereof.

In some embodiments, the front-end adapter 233 may each include logic for performing any other suitable endpoint instance-specific modifications to the message to adapt the message to the particular endpoints and/or endpoint instances affected by the performance incident. In some embodiments, the modifications may be made based on, e.g., an application type of each endpoint and/or endpoint instance, IP address, GPS location, default or selected language, user account data, IoT devices registered with the mobile application, IoT devices registered with the user account, among other endpoint instance data or any combination thereof.

In some embodiments, upon connecting with each affected endpoint instance, the respective front-end adapter 233 may, at step 402, transmit the endpoint-specific message having the endpoint instance-specific modifications to each affected endpoint instance in order to update the front-end status with the message in the local language. As a result, the message may be communicated to a variety of endpoints, including mobile applications, web application, third-party integrations, and others, in an efficient, uniform, and consistent manner.

In some embodiments, each endpoint may include a graphical user interface configured to render the message as a status update. In some embodiments, the status update may include, e.g., a pop-up, a banner, a push notification, a direct message, or other suitable interface element(s) for displaying the message to a user. In some embodiments, the status update may include interface element(s) for user interaction to confirm receipt via a confirm element, as well as other interactions via suitable interface elements, such as, a cancel element, a delete element, a remind later element, or other suitable user interactive element. In some embodiments, upon the user selecting a user interactive element of the status update, the selection may be logged and returned to the status API gateway 230 via the endpoint-specific API call to the front-end adapter 233.

In response, each endpoint instance may be configured to return an acknowledgement that confirms receipt of the message via the associated endpoint-specific API call to the front-end adapter 233. In some embodiments, the front-end adapter 233 may return the acknowledgment and any user interactions from each endpoint instance to the system states 201 and/or the admin portal adapter 232, e.g., via the routing service 231 or directly.

In some embodiments, at step 403, the front-end adapter 233 may receive the confirm or acknowledgement from the endpoint. Upon receipt, the front-end adapter 233 may update, at step 404, the front-end status with the confirmation to log the delivery of the message. In some embodiments, the update may be provided to the admin portal 242 via the admin portal adapter 232 may to update the admin portal 242 with the confirmation and/or user interactions. In some embodiments, the admin portal 242 may update a record associated with each message, such as a message record, the performance incident record and/or the planned maintenance record with data regarding user receipt and/or user response. Accordingly, the admin portal 242 may aggregate and monitor user activity statistics with respect to each message to determine the efficacy and performance of each message.

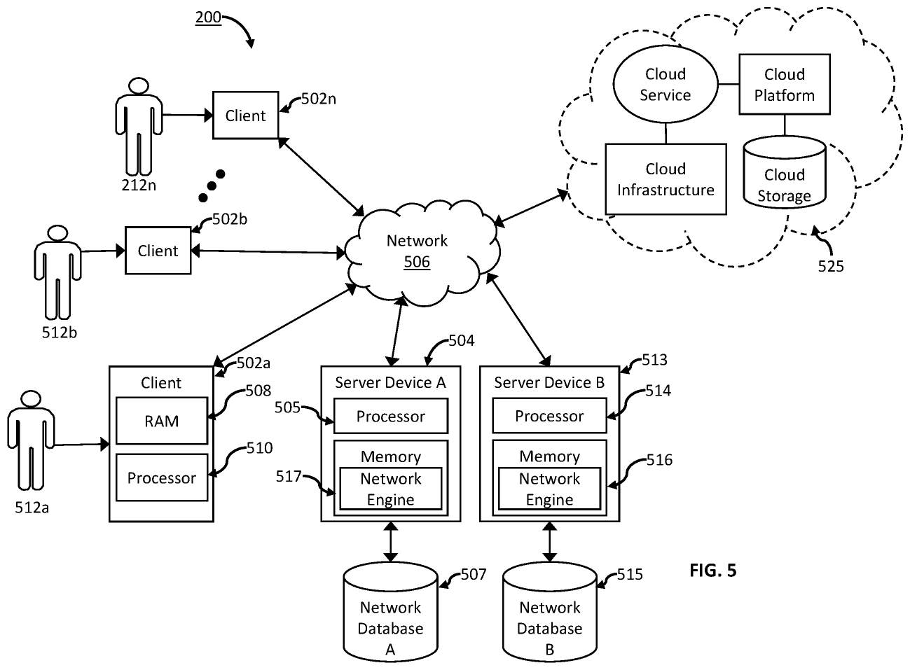

FIG. 5 depicts a block diagram of another exemplary computer-based system and platform 500 for network communication with electronic messaging, including for selective deployment of system status messages to multiple front-end endpoints in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing device 502a, member computing device 502b through member computing device 502n shown each at least includes a computer-readable medium, such as a random-access memory (RAM) 508 coupled to a processor 510 or FLASH memory. In some embodiments, the processor 510 may execute computer-executable program instructions stored in memory 508. In some embodiments, the processor 510 may include a microprocessor, an ASIC, and/or a state machine. In some embodiments, the processor 510 may include, or may be in communication with, media, for example computer-readable media, which stores instructions that, when executed by the processor 510, may cause the processor 510 to perform one or more steps described herein. In some embodiments, examples of computer-readable media may include, but are not limited to, an electronic, optical, magnetic, or other storage or transmission device capable of providing a processor, such as the processor 510 of member computer device 502a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape, or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 502a through 502n may also comprise a number of external or internal devices such as a mouse, a CD-ROM, DVD, a physical or virtual keyboard, a display, or other input or output devices. In some embodiments, examples of member computing devices 502a through 502n (e.g., clients) may be any type of processor-based platforms that are connected to a network 506 such as, without limitation, personal computers, digital assistants, personal digital assistants, smart phones, pagers, digital tablets, laptop computers, Internet appliances, and other processor-based devices. In some embodiments, member computing devices 502a through 502n may be specifically programmed with one or more application programs in accordance with one or more principles/methodologies detailed herein. In some embodiments, member computing devices 502a through 502n may operate on any operating system capable of supporting a browser or browser-enabled application, such as Microsoft™, Windows™, and/or Linux. In some embodiments, member computing devices 502a through 502n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 502a through 502n, user 512a, user 512b through user 512n, may communicate over the exemplary network 506 with each other and/or with other systems and/or devices coupled to the network 506. As shown in FIG. 5, exemplary server devices 504 and 513 may include processor 505 and processor 514, respectively, as well as memory 517 and memory 516, respectively. In some embodiments, the server devices 504 and 513 may be also coupled to the network 506. In some embodiments, one or more member computing devices 502a through 502n may be mobile clients.

In some embodiments, at least one database of exemplary databases 507 and 515 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

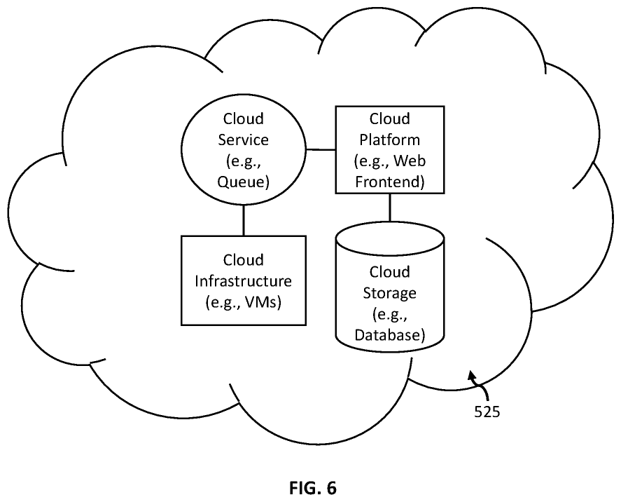

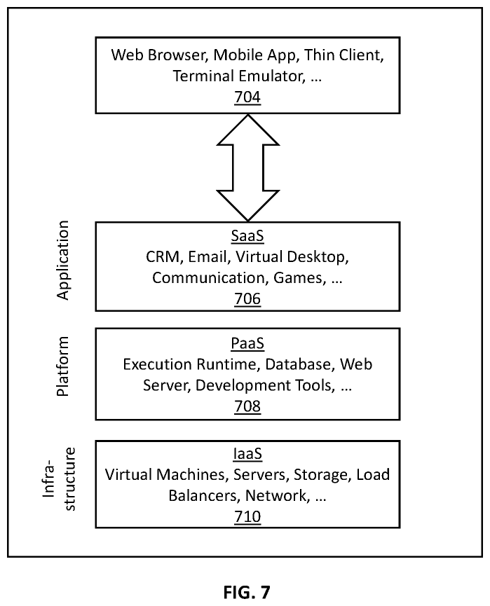

In some embodiments, the server system 105 and administration service 110 of the present disclosure may be specifically configured to operate in a cloud computing/architecture 525 such as, but not limiting to: infrastructure a service (IaaS) 710, platform as a service (PaaS) 708, and/or software as a service (Saas) 706 using a web browser, mobile app, thin client, terminal emulator, or other endpoint 704. FIGS. 6 and 7 illustrate schematics of exemplary implementations of the cloud computing/architecture(s) in which the server system 105 and administration service 110 of the present disclosure may be specifically configured to operate for network communication with electronic messaging, including for selective deployment of system status messages to multiple front-end endpoints.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

In some embodiments, the network 109, the client devices 101-104 and/or the server system 105 may be configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk™, TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical, or other forms of propagated signals (e.g., carrier waves, infrared signals, digital signals, etc.), and others.

As used herein, the terms “computer service” and “service” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) FreeBSD, NetBSD, OpenBSD; (2) Linux; (3) Microsoft Windows™; (4) OpenVMS™; (5) OS X (MacOS™); (6) UNIX™; (7) Android; (8) iOS™; (9) Embedded Linux; (10) Tizen™; (11) WebOS™; (12) Adobe AIR™; (13) Binary Runtime Environment for Wireless (BREW™); (14) Cocoa™ (API); (15) Cocoa™ Touch; (16) Java™ Platforms; (17) JavaFX™; (18) QNX™; (19) Mono; (20) Google Blink; (21) Apple WebKit; (22) Mozilla Gecko™; (23) Mozilla XUL; (24).NET Framework; (25) Silverlight™; (26) Open Web Platform; (27) Oracle Database; (28) Qt™; (29) SAP NetWeaver™; (30) Smartface™; (31) Vexi™; (32) Kubernetes™ and (33) Windows Runtime (WinRT™) or other suitable computer platforms or any combination thereof. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

In some embodiments, illustrative client devices 101-104 and/or the server system 105 of the present disclosure may be configured to handle numerous concurrent users that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, the server system 105 and/or administration service 110 of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, or objects. For example, such projections may be a visual overlay for a mobile augmented reality (MAR) application.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

As used herein, terms “proximity detection,” “locating,” “location data,” “location information,” and “location tracking” refer to any form of location tracking technology or locating method that can be used to provide a location of, for example, a particular computing device, system or platform of the present disclosure and any associated computing devices, based at least in part on one or more of the following techniques and devices, without limitation: accelerometer(s), gyroscope(s), Global Positioning Systems (GPS); GPS accessed using Bluetooth™; GPS accessed using any reasonable form of wireless and non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, Cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed; this is in no way meant to be a limitation.

As used herein, terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the illustrative computer-based systems or platforms of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTRO, SHA-1, SHA-2, Tiger (TTH), WHIRLPOOL, RNGs).

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session or can refer to an automated software application which receives the data and stores or processes the data.

The aforementioned examples are, of course, illustrative, and not restrictive.

At least some aspects of the present disclosure will now be described with reference to the following numbered clauses.
1. A method including:
   receiving, by at least one processor via a particular application programming interface (API) of an administration service, a performance incident indication indicative of a performance incident associated with at least one application service;
      where the performance incident indication includes:
         an incident type identifier identifying a type of the performance incident and at least one application service identifier identifying the at least one application service;
   determining, by the at least one processor, using the administration service, a performance incident status based at least in part on the performance incident indication;
   determining, by the at least one processor, using the administration service, at least one message including a notification of the performance incident based at least in part on:
      the performance incident status and
      the incident type identifier;
   determining, by the at least one processor, using the administration service, at least one front-end associated with the at least one application service;
   generating, by the at least one processor, using at least one front-end specific adapter of a plurality of adapters of the particular API, at least one front-end specific API call to the at least one front-end;
   updating, by the at least one processor, the at least one front-end with the at least one message using the at least one front-end specific API call so as to cause the at least one front-end to render the at least one message with front-end specific formatting;
   generating, by the at least one processor, using at least one public status page specific adapter of a plurality of adapters of the particular API, at least one public status page specific API call to at least one public status page;
   updating, by the at least one processor, using the at least one public status page specific adapter of the plurality of adapters of the particular API, the at least one public status page with the at least one message using the at least one public status page specific API call so as to cause the at least one public status page to render the at least one message with public status page specific formatting; and
   updating, by the at least one processor, a user interface of the administrative service to present an application status indicating that the at least one front-end is updated with the at least one message.
2. The method as recited in clause 1, where the performance incident indication includes a geographic location associated with the performance incident.
3. The method as recited in clause 2, further including determining, by the at least one processor, using the administration service, at least one message for alerting at least one user of the performance incident based at least in part on the geographic location.
4. The method as recited in clause 1, where the at least one front-end includes a geographic location.
5. The method as recited in clause 3, further including determining, by the at least one processor, using the administration service, at least one language of the at least one message based at least in part on the geographic location of the at least one front-end.
6. The method as recited in clause 1, further including:
   determining, by the at least one processor, at least one application type of the at least one front-end; and
   modifying, by the at least one processor, the at least one message based at least in part on the at least one application type.
7. The method as recited in clause 1, further including:
   receiving, by the at least one processor, at least one receipt confirmation from the at least one front-end, the at least one receipt confirmation confirm a receipt and a display of the at least one message by the at least one front-end; and
   updating, by the at least one processor, the user interface of the administrative service to present status confirmation report indicating that the at least one receipt confirmation of the at least one front-end for the at least one message.
8. The method as recited in clause 1, further including:
   receiving, by at least one processor via the particular API of the administration service, an updated performance incident indication indicative of an updated status of the performance incident associated with at least one application service;
   determining, by the at least one processor, using the administration service, an updated performance incident status based at least in part on the updated performance incident indication;
   determining, by the at least one processor, using the administration service, at least one updated message including an updated notification of the updated to the performance incident based at least in part on the updated performance incident indication indicative;
   updating, by the at least one processor, the at least one front-end with the at least one updated message using the at least one front-end specific API call so as to cause the at least one front-end to render the at least one updated message with the front-end specific formatting;
   updating, by the at least one processor, using the at least one public status page specific adapter of the plurality of adapters of the particular API, the at least one public status page with the at least one updated message using the at least one public status page specific API call so as to cause the at least one public status page to render the at least one updated message with public status page specific formatting; and
   updating, by the at least one processor, the user interface of the administrative service to present the application status indicating that the at least one front-end is updated with the at least one updated message.
9. A non-transitory computer readable medium having software instructions stored thereon, the software instructions configured to cause at least one processor to perform steps to:
   receive, via a particular application programming interface (API) of an administration service, a performance incident indication indicative of a performance incident associated with at least one application service;
      where the performance incident indication includes:
         an incident type identifier identifying a type of the performance incident and at least one application service identifier identifying the at least one application service;
   determine, using the administration service, a performance incident status based at least in part on the performance incident indication;
   determine, using the administration service, at least one message including a notification of the performance incident based at least in part on:
      the performance incident status and
      the incident type identifier;
   determine, using the administration service, at least one front-end associated with the at least one application service;
   generate, using at least one front-end specific adapter of a plurality of adapters of the particular API, at least one front-end specific API call to the at least one front-end;
   update, the at least one front-end with the at least one message using the at least one front-end specific API call so as to cause the at least one front-end to render the at least one message with front-end specific formatting;
   generate, using at least one public status page specific adapter of a plurality of adapters of the particular API, at least one public status page specific API call to at least one public status page;
   update, using the at least one public status page specific adapter of the plurality of adapters of the particular API, the at least one public status page with the at least one message using the at least one public status page specific API call so as to cause the at least one public status page to render the at least one message with public status page specific formatting; and
   update a user interface of the administrative service to present an application status indicating that the at least one front-end is updated with the at least one message.
10. The non-transitory computer readable medium as recited in clause 9, where the performance incident indication includes a geographic location associated with the performance incident.
11. The non-transitory computer readable medium as recited in clause 10, where the software instructions are further configured to cause the at least one processor to perform steps to determine, using the administration service, at least one message for alerting at least one user of the performance incident based at least in part on the geographic location.
12. The non-transitory computer readable medium as recited in clause 9, where the at least one front-end includes a geographic location.
13. The non-transitory computer readable medium as recited in clause 12, where the software instructions are further configured to cause the at least one processor to perform steps to determine, using the administration service, at least one language of the at least one message based at least in part on the geographic location of the at least one front-end.
14. The non-transitory computer readable medium as recited in clause 9, where the software instructions are further configured to cause the at least one processor to perform steps to:
   determine least one application type of the at least one front-end; and
   modify the at least one message based at least in part on the at least one application type.
15. The non-transitory computer readable medium as recited in clause 9, where the software instructions are further configured to cause the at least one processor to perform steps to determine:
   receive at least one receipt confirmation from the at least one front-end, the at least one receipt confirmation confirm a receipt and a display of the at least one message by the at least one front-end; and
   update the user interface of the administrative service to present status confirmation report indicating that the at least one receipt confirmation of the at least one front-end for the at least one message.
16. The non-transitory computer readable medium as recited in clause 9, where the software instructions are further configured to cause the at least one processor to perform steps to determine:
   receive, via the particular API of the administration service, an updated performance incident indication indicative of an updated status of the performance incident associated with at least one application service;
   determine, using the administration service, an updated performance incident status based at least in part on the updated performance incident indication;
   determine, using the administration service, at least one updated message including an updated notification of the updated to the performance incident based at least in part on the updated performance incident indication indicative;
   update the at least one front-end with the at least one updated message using the at least one front-end specific API call so as to cause the at least one front-end to render the at least one updated message with the front-end specific formatting;
   update, using the at least one public status page specific adapter of the plurality of adapters of the particular API, the at least one public status page with the at least one updated message using the at least one public status page specific API call so as to cause the at least one public status page to render the at least one updated message with public status page specific formatting; and
   update the user interface of the administrative service to present the application status indicating that the at least one front-end is updated with the at least one updated message.
17. A system including:
   at least one processor in communication with at least one front-end via a network;
   where the at least one processor is configured to execute software instructions stored on a non-transitory computer readable medium, where the software instructions, upon execution, cause the at least one processor to perform steps to:
      receive, via a particular application programming interface (API) of an administration service, a performance incident indication indicative of a performance incident associated with at least one application service;
         where the performance incident indication includes:
         an incident type identifier identifying a type of the performance incident and at least one application service identifier identifying the at least one application service;
      determine, using the administration service, a performance incident status based at least in part on the performance incident indication;
      determine, using the administration service, at least one message including a notification of the performance incident based at least in part on:
         the performance incident status and
         the incident type identifier;
      determine, using the administration service, at least one front-end associated with the at least one application service;
      generate, using at least one front-end specific adapter of a plurality of adapters of the particular API, at least one front-end specific API call to the at least one front-end;
      update the at least one front-end with the at least one message using the at least one front-end specific API call so as to cause the at least one front-end to render the at least one message with front-end specific formatting;
      generate, using at least one public status page specific adapter of a plurality of adapters of the particular API, at least one public status page specific API call to at least one public status page;
      update, using the at least one public status page specific adapter of the plurality of adapters of the particular API, the at least one public status page with the at least one message using the at least one public status page specific API call so as to cause the at least one public status page to render the at least one message with public status page specific formatting; and
      update a user interface of the administrative service to present an application status indicating that the at least one front-end is updated with the at least one message.
18. The system as recited in clause 17, where the software instructions are further configured to cause the at least one processor to perform steps to determine, using the administration service, at least one message for alerting at least one user of the performance incident based at least in part on a geographic location associated with the performance incident.
19. The system as recited in clause 17, where the software instructions are further configured to cause the at least one processor to perform steps to determine, using the administration service, at least one language of the at least one message based at least in part on a geographic location associated with the at least one front-end.
20. The system as recited in clause 17, where the software instructions are further configured to cause the at least one processor to perform steps to:
   receive at least one receipt confirmation from the at least one front-end, the at least one receipt confirmation confirm a receipt and a display of the at least one message by the at least one front-end; and
   update the user interface of the administrative service to present status confirmation report indicating that the at least one receipt confirmation of the at least one front-end for the at least one message.

Publications cited throughout this document are hereby incorporated by reference in their entirety. While one or more embodiments of the present disclosure have been described, it is understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

What is claimed is:

1. A method comprising:
receiving, by at least one processor via a particular application programming interface (API) of an administration service, a performance incident indication indicative of a performance incident associated with at least one application service;
wherein the performance incident indication comprises:
an incident type identifier identifying a type of the performance incident and at least one application service identifier identifying the at least one application service;
determining, by the at least one processor, using the administration service, a performance incident status based at least in part on the performance incident indication;
determining, by the at least one processor, using the administration service, at least one message comprising a notification of the performance incident based at least in part on:
the performance incident status and
the incident type identifier;
determining, by the at least one processor, using the administration service, at least one front-end associated with the at least one application service;
generating, by the at least one processor, using at least one front-end specific adapter of a plurality of adapters of the particular API, at least one front-end specific API call to the at least one front-end;
updating, by the at least one processor, the at least one front-end with the at least one message using the at least one front-end specific API call so as to cause the at least one front-end to render the at least one message with front-end specific formatting;
generating, by the at least one processor, using at least one public status page specific adapter of a plurality of adapters of the particular API, at least one public status page specific API call to at least one public status page;
updating, by the at least one processor, using the at least one public status page specific adapter of the plurality of adapters of the particular API, the at least one public status page with the at least one message using the at least one public status page specific API call so as to cause the at least one public status page to render the at least one message with public status page specific formatting; and
updating, by the at least one processor, a user interface of the administrative service to present an application status indicating that the at least one front-end is updated with the at least one message.

2. The method as recited in claim 1, wherein the performance incident indication comprises a geographic location associated with the performance incident.

3. The method as recited in claim 2, further comprising determining, by the at least one processor, using the administration service, at least one message for alerting at least one user of the performance incident based at least in part on the geographic location.

4. The method as recited in claim 1, wherein the at least one front-end comprises a geographic location.

5. The method as recited in claim 3, further comprising determining, by the at least one processor, using the administration service, at least one language of the at least one message based at least in part on the geographic location of the at least one front-end.

6. The method as recited in claim 1, further comprising:
determining, by the at least one processor, at least one application type of the at least one front-end; and
modifying, by the at least one processor, the at least one message based at least in part on the at least one application type.

7. The method as recited in claim 1, further comprising:
receiving, by the at least one processor, at least one receipt confirmation from the at least one front-end, the at least one receipt confirmation confirm a receipt and a display of the at least one message by the at least one front-end; and
updating, by the at least one processor, the user interface of the administrative service to present status confirmation report indicating that the at least one receipt confirmation of the at least one front-end for the at least one message.

8. The method as recited in claim 1, further comprising:
receiving, by at least one processor via the particular API of the administration service, an updated performance incident indication indicative of an updated status of the performance incident associated with at least one application service;
determining, by the at least one processor, using the administration service, an updated performance incident status based at least in part on the updated performance incident indication;
determining, by the at least one processor, using the administration service, at least one updated message comprising an updated notification of the updated to the performance incident based at least in part on the updated performance incident indication indicative;
updating, by the at least one processor, the at least one front-end with the at least one updated message using the at least one front-end specific API call so as to cause the at least one front-end to render the at least one updated message with the front-end specific formatting;
updating, by the at least one processor, using the at least one public status page specific adapter of the plurality of adapters of the particular API, the at least one public status page with the at least one updated message using the at least one public status page specific API call so as to cause the at least one public status page to render the at least one updated message with public status page specific formatting; and
updating, by the at least one processor, the user interface of the administrative service to present the application status indicating that the at least one front-end is updated with the at least one updated message.

9. A non-transitory computer readable medium having software instructions stored thereon, the software instructions configured to cause at least one processor to perform steps to:
receive, via a particular application programming interface (API) of an administration service, a performance incident indication indicative of a performance incident associated with at least one application service;
wherein the performance incident indication comprises:
an incident type identifier identifying a type of the performance incident and at least one application service identifier identifying the at least one application service;
determine, using the administration service, a performance incident status based at least in part on the performance incident indication;
determine, using the administration service, at least one message comprising a notification of the performance incident based at least in part on:
the performance incident status and
the incident type identifier;
determine, using the administration service, at least one front-end associated with the at least one application service;
generate, using at least one front-end specific adapter of a plurality of adapters of the particular API, at least one front-end specific API call to the at least one front-end;
update, the at least one front-end with the at least one message using the at least one front-end specific API call so as to cause the at least one front-end to render the at least one message with front-end specific formatting;
generate, using at least one public status page specific adapter of a plurality of adapters of the particular API, at least one public status page specific API call to at least one public status page;
update, using the at least one public status page specific adapter of the plurality of adapters of the particular API, the at least one public status page with the at least one message using the at least one public status page specific API call so as to cause the at least one public status page to render the at least one message with public status page specific formatting; and
update a user interface of the administrative service to present an application status indicating that the at least one front-end is updated with the at least one message.

10. The non-transitory computer readable medium as recited in claim 9, wherein the performance incident indication comprises a geographic location associated with the performance incident.

11. The non-transitory computer readable medium as recited in claim 10, wherein the software instructions are further configured to cause the at least one processor to perform steps to determine, using the administration service, at least one message for alerting at least one user of the performance incident based at least in part on the geographic location.

12. The non-transitory computer readable medium as recited in claim 9, wherein the at least one front-end comprises a geographic location.

13. The non-transitory computer readable medium as recited in claim 12, wherein the software instructions are further configured to cause the at least one processor to perform steps to determine, using the administration service, at least one language of the at least one message based at least in part on the geographic location of the at least one front-end.

14. The non-transitory computer readable medium as recited in claim 9, wherein the software instructions are further configured to cause the at least one processor to perform steps to:
determine least one application type of the at least one front-end; and
modify the at least one message based at least in part on the at least one application type.

15. The non-transitory computer readable medium as recited in claim 9, wherein the software instructions are further configured to cause the at least one processor to perform steps to determine:
receive at least one receipt confirmation from the at least one front-end, the at least one receipt confirmation confirm a receipt and a display of the at least one message by the at least one front-end; and
update the user interface of the administrative service to present status confirmation report indicating that the at least one receipt confirmation of the at least one front-end for the at least one message.

16. The non-transitory computer readable medium as recited in claim 9, wherein the software instructions are further configured to cause the at least one processor to perform steps to determine:
receive, via the particular API of the administration service, an updated performance incident indication indicative of an updated status of the performance incident associated with at least one application service;
determine, using the administration service, an updated performance incident status based at least in part on the updated performance incident indication;
determine, using the administration service, at least one updated message comprising an updated notification of the updated to the performance incident based at least in part on the updated performance incident indication indicative;
update the at least one front-end with the at least one updated message using the at least one front-end specific API call so as to cause the at least one front-end to render the at least one updated message with the front-end specific formatting;
update, using the at least one public status page specific adapter of the plurality of adapters of the particular API, the at least one public status page with the at least one updated message using the at least one public status page specific API call so as to cause the at least one public status page to render the at least one updated message with public status page specific formatting; and
update the user interface of the administrative service to present the application status indicating that the at least one front-end is updated with the at least one updated message.

17. A system comprising:
at least one processor in communication with at least one front-end via a network;
wherein the at least one processor is configured to:
receive, via a particular application programming interface (API) of an administration service, a performance incident indication indicative of a performance incident associated with at least one application service;
wherein the performance incident indication comprises:
an incident type identifier identifying a type of the performance incident and at least one application service identifier identifying the at least one application service;
determine, using the administration service, a performance incident status based at least in part on the performance incident indication;
determine, using the administration service, at least one message comprising a notification of the performance incident based at least in part on:
the performance incident status and
the incident type identifier;
determine, using the administration service, at least one front-end associated with the at least one application service;
generate, using at least one front-end specific adapter of a plurality of adapters of the particular API, at least one front-end specific API call to the at least one front-end;
update the at least one front-end with the at least one message using the at least one front-end specific API call so as to cause the at least one front-end to render the at least one message with front-end specific formatting;
generate, using at least one public status page specific adapter of a plurality of adapters of the particular API, at least one public status page specific API call to at least one public status page;
update, using the at least one public status page specific adapter of the plurality of adapters of the particular API, the at least one public status page with the at least one message using the at least one public status page specific API call so as to cause the at least one public status page to render the at least one message with public status page specific formatting; and
update a user interface of the administrative service to present an application status indicating that the at least one front-end is updated with the at least one message.

18. The system as recited in claim 17, wherein the software instructions are further configured to cause the at least one processor to perform steps to determine, using the administration service, at least one message for alerting at least one user of the performance incident based at least in part on a geographic location associated with the performance incident.

19. The system as recited in claim 17, wherein the software instructions are further configured to cause the at least one processor to perform steps to determine, using the administration service, at least one language of the at least one message based at least in part on a geographic location associated with the at least one front-end.

20. The system as recited in claim 17, wherein the software instructions are further configured to cause the at least one processor to perform steps to:
receive at least one receipt confirmation from the at least one front-end, the at least one receipt confirmation confirm a receipt and a display of the at least one message by the at least one front-end; and
update the user interface of the administrative service to present status confirmation report indicating that the at least one receipt confirmation of the at least one front-end for the at least one message.
